(19) United States
(12) Patent Application Publication
(10) Pub. No.: US 2009/0046552 A1
(43) Pub. Date: Feb. 19, 2009

(54) MEDIUM CONTROL DEVICE, MEDIUM CONTROL METHOD, AND RECORDING MEDIUM

(75) Inventor: Eiji TSUKADA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawaskai (JP)

(21) Appl. No.: 12/191,044

(22) Filed: Aug. 13, 2008

(30) Foreign Application Priority Data
Aug. 16, 2007 (JP) 2007-212364

(51) Int. Cl. G11B 20/18

(52) U.S. Cl. 369/53.17; G9B/20.046

(57) ABSTRACT

A medium control device for accepting a medium, reading from or writing to the medium, and monitoring for errors that occur while reading or writing provides a quality determiner for determining whether the quality of the medium has deteriorated based on errors by monitoring for the errors that occur while reading or writing, and a quality marker for marking a message indicating deterioration of the quality of the medium on a label side of the medium when the quality determiner determines that the quality of the medium has deteriorated.

### CROSS-REFERENCE TO RELATED APPLICATIONS

This application is related to and claims priority to Japanese patent application No. 2007-212364 filed on Aug. 16, 2007, in the Japan Patent Office, the entire contents of which are incorporated by reference herein.

### BACKGROUND OF THE INVENTION

1. Field of the Invention

The present invention relates to a medium control device that accepts a medium, reads from or writes to the medium, and monitors for errors that occur while reading or writing, a medium control method, and a recording medium.

2. Description of the Related Art

A conventional technology to notify a user of a quality state of a medium by displaying an error rate indicating an error frequency during playback of the medium in a monitoring device is disclosed as a technology to prevent data losses.

However, according to the above conventional technology, only the quality state of the medium during playback is displayed. Whether the quality of the medium has deteriorated or not cannot be recognized after the medium is removed from a medium control device. Thus, there is a problem that the user mistakenly continues to use a medium whose quality has deteriorated until the medium ultimately becomes impossible to play back or write to, leading to data losses.

### SUMMARY OF THE INVENTION

The present invention is a medium control device that accepts a medium, reads from or writes to the medium, and monitors for errors that occur while reading or writing, and comprises a quality determiner for determining whether medium quality has deteriorated based on errors by monitoring for errors that occur while reading or writing, and a quality marker for marking a message indicating deterioration of the quality of a medium on a label side of the medium when the quality determiner determines that the quality of the medium has deteriorated.

The above-described embodiments of the present invention are intended as examples, and all embodiments of the present invention are not limited to including the features described above.

### BRIEF DESCRIPTION OF THE DRAWINGS

FIG. 1 is a diagram for illustrating an overview and features of a medium control device according to a first embodiment;

FIG. 2 is a block diagram showing a configuration of the medium control device according to the first embodiment;

FIG. 3 is a diagram exemplifying print content;

FIG. 4 is a flow chart showing operations of a quality determination process of the medium control device according to the first embodiment;

FIG. 5 is a flow chart showing operations of a printing process of the medium control device according to the first embodiment;

FIG. 6 is a diagram for illustrating the overview and features of a medium control device according to a second embodiment; and

FIG. 7 is a flow chart showing operations of a printing process of the medium control device according to the second embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

A medium control device, a medium control method, and a medium control program according to the present invention will be described below in more detail with reference to the attached drawings.

### First Embodiment

In an embodiment below, description will be made of the overview and features of a medium control device according to a first embodiment, the configuration of the medium control device, and the flow of processing are described in turn and lastly, an effect by the first embodiment. An example in which the present invention is applied to a medium control device having a read/write function of CD-R, CD-RW, DVD-R, DVD±RW, DVD-RAM, magnetic disk, optical disk and the like (hereinafter, referred to as media) will be described below.

### Overview and Features of the Medium Control Device According to the First Embodiment

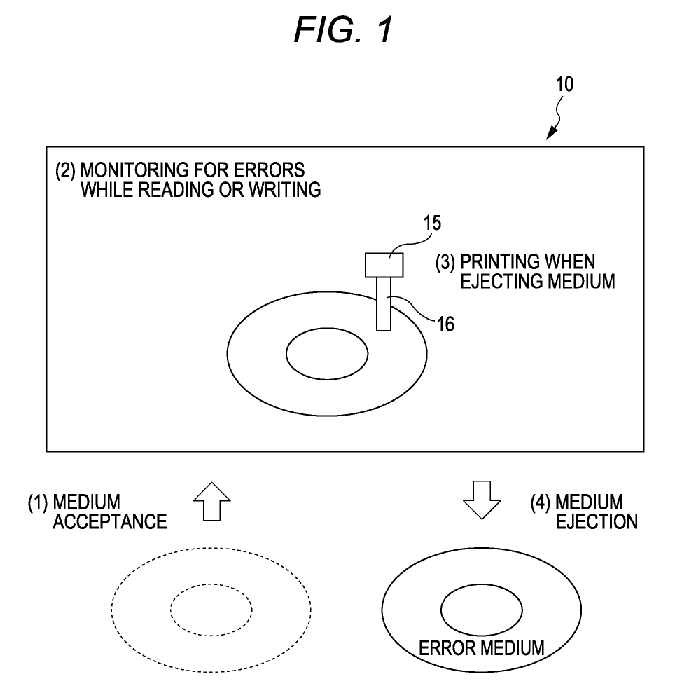

First, the configuration and features of the medium control device according to the first embodiment will be described using FIG. 1. FIG. 1 is a diagram for illustrating the overview and features of the medium control device according to the first embodiment.

A basic function of a medium control device 10 in the first embodiment is to accept a medium to read from or write to the medium and monitors for errors while reading or writing. The medium control device 10 is typically characterized in that data losses are prevented.

The main features of the medium control device 10 will be more specifically described. After accepting a medium (See (1) in FIG. 1), the medium control device 10 monitors for errors that occur while reading from or writing to the medium. The medium control device 10 determines whether the quality of the medium has deteriorated based on errors (See (2) in FIG. 1). More specifically, the medium control device 10 determines whether or not the retry count of reading from the medium or the number of times that the processing time of a read command exceeds a monitoring time of the operating system, a tracking error value, a focus error value, or a reflected light level value exceeds respective preset threshold values.

Subsequently, if the quality of the medium is determined to have deteriorated when the medium is ejected, the medium control device 10 prints a message indicating deterioration of the quality of the medium on the label side of the medium using a stamp 16 provided in a solenoid 15 (See (3) in FIG. 1) before ejecting the medium (See (4) in FIG. 1). For example, as exemplified in FIG. 1, the medium control device 10 prints “Error medium” on the label side of the medium.

The medium control device 10 allows the user to recognize that quality of a medium has deteriorated before the medium becomes impossible to play back or write to and therefore, like the above main features, data losses can be prevented.

Configuration of the Medium Control Device

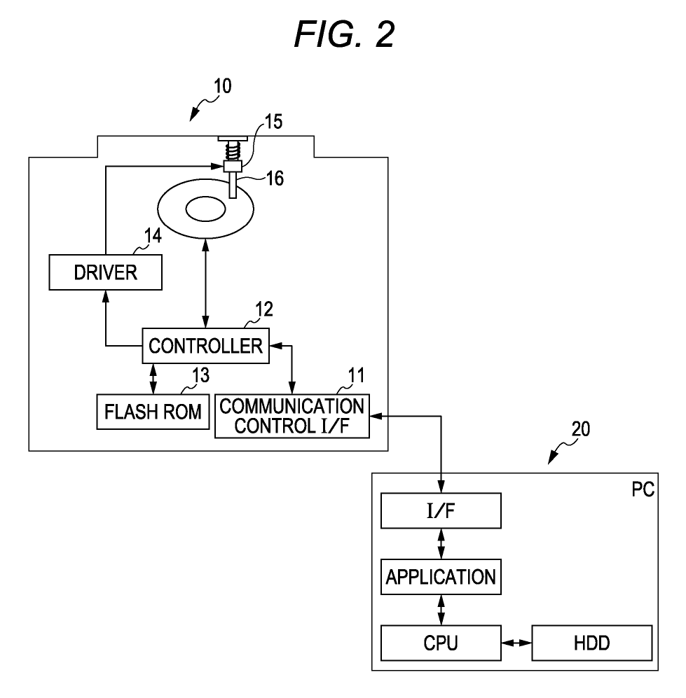

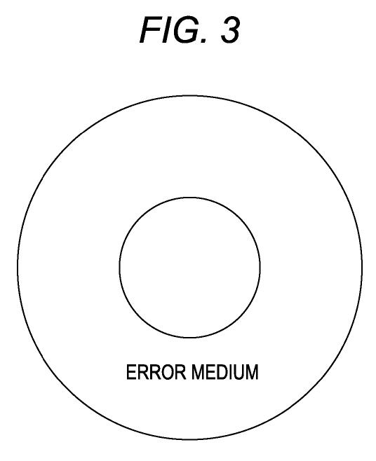

Next, the configuration of the medium control device 10 shown in FIG. 1 will be described using FIGS. 2 and 3. FIG. 2 is a block diagram showing the configuration of the medium control device 10 according to the first embodiment, and FIG. 3 is a diagram exemplifying print content.

As shown in FIG. 2, the medium control device 10 includes a communication control I/F 11, a controller 12, a Flash ROM 13, a driver 14, the solenoid 15, and the stamp 16, and is connected to a PC 20 via a port or the like. Processing of each of these components will be described below. Incidentally, the controller 12 corresponds to the “quality determiner” in claims and the stamp 16 to the “quality marker” in claims.

The communication control I/F 11 controls communication of various kinds of information performed with the connected PC 20. More specifically, the communication control I/F 11 receives read and write requests from the PC 20 and transmits data read from a medium to the PC 20.

The controller 12 not only performs control to read from or write to a medium, but also monitors for errors that occur while reading or writing to determine whether the quality of the medium has deteriorated based on errors. More specifically, the controller 12 determines whether or not the retry count of reading from the medium or the number of times that the processing time of a read command exceeds a monitoring time of the operating system, tracking error value, focus error value, or reflected light level value exceeds respective preset threshold values. If, as a result, the controller 12 determines that some threshold value has been exceeded, the controller 12 sets a flag indicating that quality of the medium has deteriorated.

The Flash ROM 13 is rewritable. The Flash ROM 13 is a non-volatile semiconductor memory in which data is retained even after power-off. The Flash ROM 13 stores data and programs necessary for various processes by the controller 12. The driver 14 receives a driving signal from the controller 12 to control the solenoid 15 based on the driving signal. The solenoid 15 is an actuator driving on a medium and the stamp 16 described later is provided at a tip of the solenoid 15.

The stamp 16 is provided at the tip of the solenoid 15. The stamp 16 does not require refilling. The stamp 16 prints a message indicating deterioration of the quality of the medium on the label side of the medium if a flag indicating that quality of a medium has deteriorated is set when the medium is ejected. More specifically, as exemplified in FIG. 3, the stamp 16 prints “Error medium” on the label side of the medium. The content to be printed may be any that allows the user to visually recognize that quality of the medium has deteriorated. The content to be printed may be “E”, “Not usable”, or “Copy data because the medium has deteriorated”. In addition to the above type that does not require refilling, laser printing or inkjet printing may also be used.

Processing by the Medium Control Device

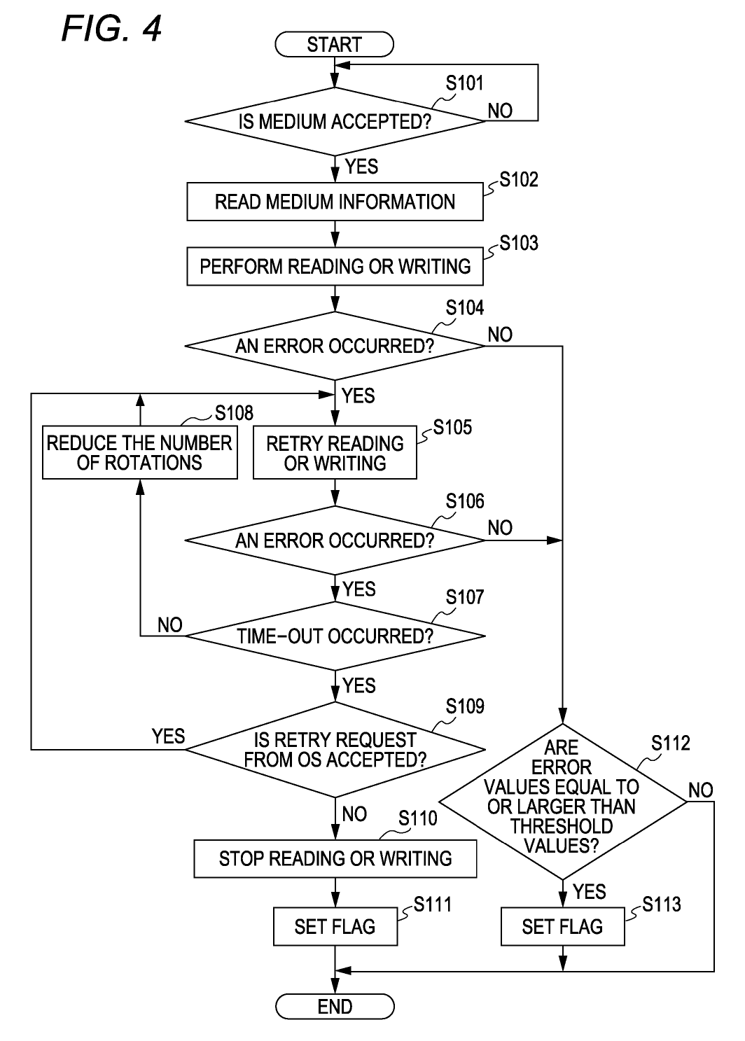

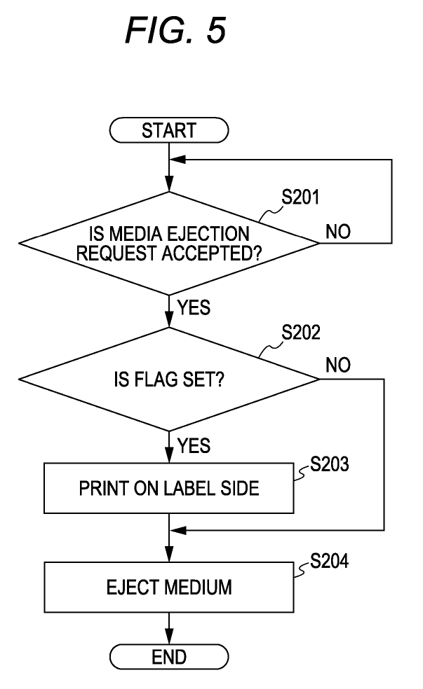

Next, processing by the medium control device 10 according to the first embodiment will be described using FIG. 4. FIG. 4 is a flow chart showing operations of a quality determination process of the medium control device 10 according to the first embodiment, and FIG. 5 is a flow chart showing operations of a printing process of the medium control device 10 according to the first embodiment.

As shown in FIG. 4, after accepting a medium (Yes in operation S101), the medium control device 10 reads media information (for example, TOC, A-TIP, or A-DIP) from the medium (operation S102). If media information cannot be read, the medium control device 10 itself is determined to be malfunctioning.

Subsequently, the medium control device 10 reads from or writes to the medium (operation S103) and monitors for errors that occur while reading or writing to determine whether any error has occurred (operation S104). If, as a result, the medium control device 10 determines that an error has occurred (Yes in operation S104), the medium control device 10 performs retry processing of reading or writing (operation S105) to determine whether an error has occurred (operation S106). If, as a result, the medium control device 10 determines that an error has occurred (Yes in operation S106), the medium control device 10 determines whether any time-out exceeding the monitoring time of the operating system has occurred (operation S107).

If, as a result, the medium control device 10 determines that no time-out has occurred (No in operation S107), the medium control device 10 performs retry processing of reading or writing (operation S105) after reducing the number of rotations (operation S108). If a time-out has occurred (Yes in operation S107), the medium control device 10 determines whether to retry by resetting the monitoring time depending on a decision of the operating system. If, as a result, reading or writing should be retried (Yes in operation S109), the medium control device 10 repeats retry processing of reading or writing by returning to operation S105. If, on the other hand, reading or writing should be not retried (No in operation S109), the medium control device 10 stops reading or writing (operation S110) and sets a flag indicating that quality of the medium has deteriorated (operation S111).

If, on the other hand, the medium control device 10 determines that no error has occurred at operation S104 or operation S106 (No in operation S104; No in operation S106), the medium control device 10 determines whether values concerning errors (the retry count, time-out count, tracking error value, focus error value, or reflected light level value) that have occurred are equal to or more than threshold values (operation S112). If values concerning errors that have occurred are less than respective threshold values (No in operation S112), the process is terminated immediately.

Next, a printing process of the medium control device 10 will be described using FIG. 5. As shown in FIG. 5, after receiving a media ejection request (Yes in operation S201), the medium control device 10 determines whether any flag indicating that quality of the medium has deteriorated is set (operation S202).

If, as a result, the medium control device 10 determines that a flag is set (Yes in operation S202), the medium control device 10 prints a message indicating deterioration of the quality of the medium using the stamp 16 (operation S203) and, if no flag is set (No in operation S202), the medium control device 10 proceeds to operation S204 without printing any message. Subsequently, the medium control device 10 ejects the medium (operation S204) to terminate the process.

### Effect of the First Embodiment

The medium control device 10 allows the user to recognize that quality of a medium has deteriorated before the medium becomes impossible to play back or write to, as described above, and therefore, data losses can be prevented.

According to the first embodiment, whether the quality of a medium has deteriorated can appropriately be determined by monitoring the number of times of retrying to read data from a medium and the number of times that the processing time of a read commend exceeds a monitoring time of the operating time.

Also, according to the first embodiment, whether the quality of a medium has deteriorated can appropriately be determined by monitoring the tracking error value, focus error value, and reflected light level value.

### Second Embodiment

Incidentally, in the first embodiment, a message is printed on a medium when values concerning errors that have occurred are equal to or more than some threshold value, but the present invention is not limited to this. If values concerning errors that have occurred are equal to or more than some threshold value and the range where errors have occurred is equal to less than a threshold value, a message may be printed on a medium.

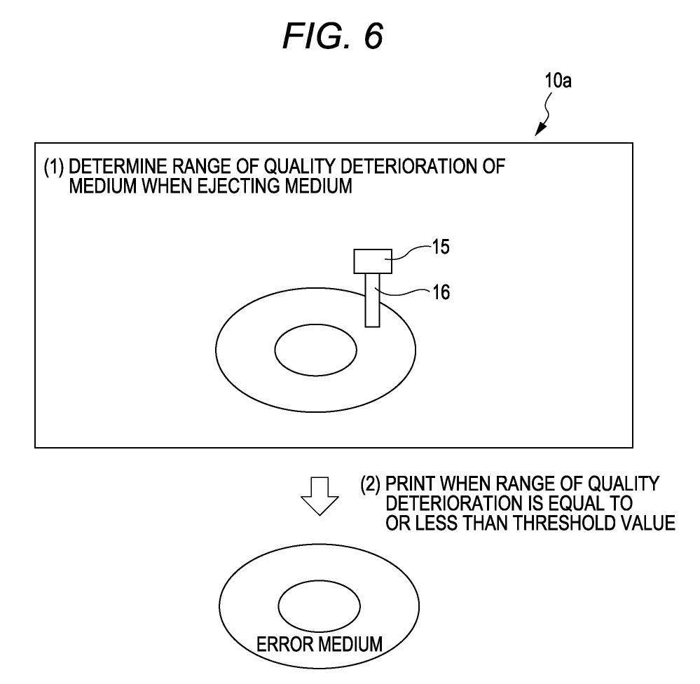

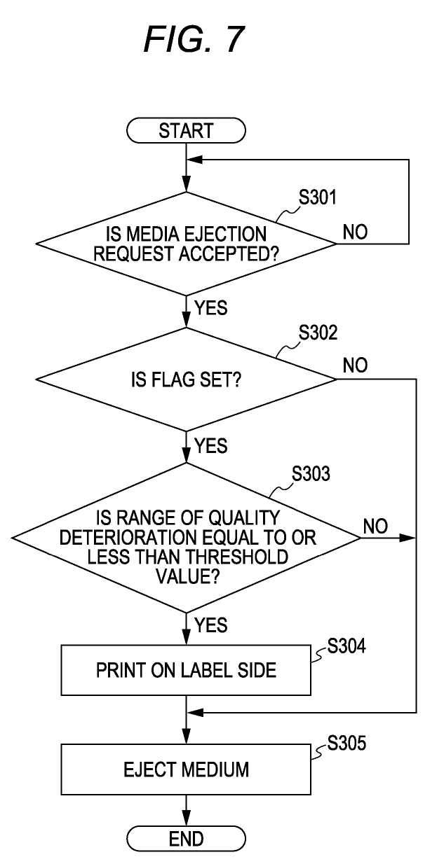

Thus, in the second embodiment, the overview, features, and processing of a medium control device 10a in the second embodiment will be described using FIGS. 6 and 7 as a case in which values concerning errors that have occurred are equal to or more than some threshold value and the range where errors have occurred is equal to less than a threshold value. FIG. 6 is a diagram for illustrating the overview and features of the medium control device 10a according to the second embodiment, and FIG. 7 is a flow chart showing operations of a printing process of the medium control device 10a according to the second embodiment.

First, the overview and features of the medium control device 10a according to the second embodiment will be described. As shown in FIG. 6, like the first embodiment, the medium control device 10a determines whether the quality of a medium has deteriorated. Then, if the quality of the medium is determined to have deteriorated when the medium is ejected, the medium control device 10a further determines whether the range where the quality of the medium has deteriorated is equal to or less than a predetermined threshold value (See (1) in FIG. 6).

If, as a result, the medium control device 10a determines that the range where the quality of the medium has deteriorated is equal to or less than a predetermined threshold value, the medium control device 10a drives the solenoid 15 to print a message indicating deterioration of the quality of the medium on the label side of the medium using the stamp 16 (See (2) in FIG. 6). That is, if the range where the quality of the medium has deteriorated is large, it is assumed that errors are caused by dust, dirt or the like and a message indicating deterioration of the quality of the medium is not printed. If, on the other hand, the range where the quality of the medium has deteriorated is small, it is assumed that errors are caused by poor quality of the medium and a message indicating deterioration of the quality of the medium is printed.

Next, processing by the medium control device 10a according to the second embodiment will be described using FIG. 7. Access control processing in the second embodiment is different from the printing process according to the first embodiment shown in FIG. 5 in that whether the range where the quality of the medium has deteriorated is equal to or less than a threshold value.

That is, as shown in FIG. 7, after receiving a media ejection request (Yes in operation S301), like the first embodiment, the medium control device 10a determines whether any flag indicating that quality of a medium has deteriorated is set (operation S302). Then, in contrast to the first embodiment, if a flag is set (Yes in operation S302), the medium control device 10a determines whether the range where the quality of the medium has deteriorated is equal to or less than a threshold value (operation S303).

If the range where the quality of the medium has deteriorated is equal to or less than the threshold value (Yes in operation S303), the medium control device 10a prints a message indicating deterioration of the quality of the medium on the label side of the medium using the stamp 16 (operation S304). If, on the other hand, no flag is set at operation S302 (No in operation S302) or the range where the quality of the medium has deteriorated is more than a threshold value at operation S303 (No in operation S303), the medium control device 10a proceeds to operation S305 without printing any message. Subsequently, the medium control device 10 ejects the medium (operation S304) to terminate the process.

Thus, in the second embodiment, if the range where the quality of a medium has deteriorated is large, a message indicating deterioration of the quality of the medium is not printed assuming that errors are caused by dust, dirt or the like. If, on the other hand, the range where the quality of a medium has deteriorated is small, a message indicating deterioration of the quality of the medium is printed assuming that errors are caused by poor quality of the medium and therefore, media recoverable by wiping out dust, dirt or the like can be prevented from being printed.

### Third Embodiment

Embodiments of the present invention have been described, but the present invention is not limited to these embodiments and may be carried out in various modifications within the scope of technical ideas described in claims. Moreover, effects described in embodiments are not limited to these.

Various kinds of processes described in the above embodiments can be realized by executing prepared programs in a processing unit of CPU (or MCU or MPU) provided in a medium control device. In the example shown in FIG. 2, various programs for realizing various kinds of processes described above are stored in the Flash ROM 13 and various processes to realize the above function to control to print on a medium whose quality has deteriorated are started by various kinds of relevant programs being read and executed by the controller 12.

Incidentally, these various kinds of programs need not be stored in the Flash ROM 13 in advance and may be read from a portable physical storage medium or an external computer connected via a network when needed before being executed by the CPU.

Various kinds of processes described above are not limited to those whose code stored in the Flash ROM 13 in advance is read by the CPU for execution and may be realized by wired logic.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A medium control device for accepting a medium, reading from or writing to the medium, and monitoring for errors that occur while reading or writing, comprising:
a quality determiner for determining whether the quality of the medium has deteriorated based on errors by monitoring for the errors that occur while reading or writing; and
a quality marker for marking a message indicating deterioration of the quality of the medium on a label side of the medium when the quality determiner determines that the quality of the medium has deteriorated.

2. The medium control device according to claim 1, wherein the quality determiner monitors a number of times of retrying to read data from the medium or a number of times that a processing time of a read command exceeds a monitoring time of an operating system as errors that occur for the reading to determine whether the number of times of retrying or the number of times of exceeding the monitoring time is equal to or more than a predetermined threshold value, and
the quality marker marks a message indicating deterioration of the quality of the medium on the label side of the medium when the quality determiner determines that the number of times of retrying or the number of times of exceeding the monitoring time is equal to or more than the predetermined threshold value.

3. The medium control device according to claim 1, wherein the quality determiner monitors one or a plurality of a tracking error value, a focus error value, and a reflected light level value as errors that occur for the writing to determine whether one or the plurality of the tracking error value, focus error value, and reflected light level value exceeds respective predetermined threshold values, and
the quality marker marks a message indicating deterioration of the quality of the medium on the label side of the medium when the quality determiner determines that the tracking error value, the focus error value, or the reflected light level value is equal to or more than the respective predetermined threshold value.

4. The medium control device according to claim 1, wherein the quality determiner further determines whether a range where the quality of the medium has deteriorated is equal to or less than a predetermined threshold value when the quality of the medium is determined to have deteriorated, and
the quality marker marks a message indicating deterioration of the quality of the medium on the label side of the medium when the quality determiner determines that the range where the quality of the medium has deteriorated is equal to or less than the predetermined threshold value.

5. A medium control method for accepting a medium, reading from or writing to the medium, and monitoring for errors that occur while reading or writing, comprising:
determining whether the quality of the medium has deteriorated based on errors by monitoring for the errors that occur while reading or writing; and
marking a message indicating deterioration of the quality of the medium on a label side of the medium when the quality has deteriorated.

6. A computer readable recording medium recording a medium control program for causing a computer to perform:
a medium control method for accepting a medium, reading from or writing to the medium, and monitoring for errors that occur while reading or writing to perform;
a quality determination procedure for determining whether the quality of the medium has deteriorated based on errors by monitoring for the errors that occur while reading or writing; and
a quality marking procedure for marking a message indicating deterioration of the quality of the medium on a label side of the medium when the quality determination procedure determines that the quality of the medium has deteriorated.
